(19) United States
(12) Patent Application Publication
(10) Pub. No.: US 2014/0006075 A1
(43) Pub. Date: Jan. 2, 2014

(54) Assigning a Consultant to an Enterprise System

(71) Applicants: Itzhak Shoshan, Petach Tikva (IL); Avi Rokach, Kfar-Saba (IL); Ronit Izhar, Ramat-Gan (IL); Jacob Vaidyan, Hampton (GB)

(72) Inventors: Itzhak Shoshan, Petach Tikva (IL); Avi Rokach, Kfar-Saba (IL); Ronit Izhar, Ramat-Gan (IL); Jacob Vaidyan, Hampton (GB)

(73) Assignee: SAP AG, Walldorf (DE)

(21) Appl. No.: 13/535,524

(22) Filed: Jun. 28, 2012

(51) Int. Cl. G06Q 10/06

(52) U.S. Cl. 705/7.14

(57) ABSTRACT

A computer-implemented method for assigning a consultant to an enterprise system includes: receiving an input that indicates a need regarding an enterprise system; selecting, based on the input and using one or more processors, at least one of multiple task-object pairs as corresponding to the need, each of the task-object pairs including a task identifier and an object identifier, wherein the object identifier specifies an aspect of the enterprise system and the task identifier specifies a task performed on the aspect; selecting, in a consultant repository and using one or more processors, one or more consultant identifiers as being associated with the selected at least one task-object pair; and presenting the selected one or more consultant identifiers in response to the input.

### BACKGROUND

This patent application relates to assigning consultants to enterprise systems.

Enterprise systems or other business systems generally require a substantial amount of configuration in order to be tailored to the needs and particular circumstances of the particularly company or organization who is planning to use the system. For this reason, extensive consultation work is sometimes performed as part of installing and implementing the enterprise system. Generally, the system customer has identified one or more particular business problems and expects the system to provide a solution thereto. The consultant, in contrast, is a person with technical and functional knowledge about the general type of system that the customer is purchasing, and the consultant expects to apply that knowledge in preparing the enterprise system for the customer. Sometimes, the sales and management employees of the system manufacturer act as the translator between the customer and the consultants, in terms of understanding the customer's needs and recommending the consultant whose skills and experience are most applicable to that situation.

### SUMMARY

In a first aspect, a computer-implemented method for assigning a consultant to an enterprise system includes: receiving an input that indicates a need regarding an enterprise system; selecting, based on the input and using one or more processors, at least one of multiple task-object pairs as corresponding to the need, each of the task-object pairs including a task identifier and an object identifier, wherein the object identifier specifies an aspect of the enterprise system and the task identifier specifies a task performed on the aspect; selecting, in a consultant repository and using one or more processors, one or more consultant identifiers as being associated with the selected at least one task-object pair; and presenting the selected one or more consultant identifiers in response to the input.

In a second aspect, a computer program product is tangibly embodied in a computer-readable storage medium and includes instructions that when executed by a processor perform a method for assigning a consultant to an enterprise system. The method includes: receiving an input that indicates a need regarding an enterprise system; selecting, based on the input and using one or more processors, at least one of multiple task-object pairs as corresponding to the need, each of the task-object pairs including a task identifier and an object identifier, wherein the object identifier specifies an aspect of the enterprise system and the task identifier specifies a task performed on the aspect; selecting, in a consultant repository and using one or more processors, one or more consultant identifiers as being associated with the selected at least one task-object pair; and presenting the selected one or more consultant identifiers in response to the input.

In a third aspect, a system includes: one or more processors; and a computer program product comprising instructions that when executed cause performance of a method. The method includes: receiving an input that indicates a need regarding an enterprise system; selecting, based on the input and using one or more processors, at least one of multiple task-object pairs as corresponding to the need, each of the task-object pairs including a task identifier and an object identifier, wherein the object identifier specifies an aspect of the enterprise system and the task identifier specifies a task performed on the aspect; selecting, in a consultant repository and using one or more processors, one or more consultant identifiers as being associated with the selected at least one task-object pair; and presenting the selected one or more consultant identifiers in response to the input.

Implementations can include any or all of the following features. A customer who made the input selects one of the presented consultant identifiers for the need, and the method further includes managing booking, matching and operations processes regarding the selected consultant. The method further includes assigning identifiers in the consultant repository to respective ones of multiple profiles, wherein selecting the one or more consultant identifiers comprises determining whether a candidate consultant having a first profile has previously performed the task, and if not, determining whether another candidate consultant having the first profile has previously performed the task. The method further includes organizing the multiple profiles in a tree-shaped taxonomy, wherein selecting the one or more consultant identifiers comprises taking into account a closeness in the tree-shaped taxonomy to a candidate consultant who has performed the task. The method further includes associating at least two task identifiers with each other based on the candidate consultant having performed at least two tasks corresponding to the task identifiers, wherein selecting the one or more consultant identifiers comprises taking into account the association. The method further includes receiving performance feedback regarding the need for at least one of the presented consultant identifiers, and updating the association between the at least one consultant and the task-object pair using the performance feedback. The method further includes associating at least two task-object pairs with each other based on consultants having performed at least two tasks corresponding to the task identifiers, wherein selecting the one or more consultant identifiers comprises taking into account the association.

Implementations can provide any or all of the following advantages. Consultant booking can be improved. The entire process of finding and evaluating a consultant, and engaging the consultant to perform services in support of an enterprise system, can be aided by a consultant self-service process. Contract formation between a customer and a consultant can be made easier.

The details of one or more implementations are set forth in the accompanying drawings and the description below. Other features and advantages will be apparent from the description and drawings, and from the claims.

### DESCRIPTION OF DRAWINGS

FIG. 1 shows an example of a system that can assign a consultant to support an enterprise system.

FIG. 2 shows an example of a process flow for a consulting self-service (CSS) process.

FIGS. 3A-C show an example of another process flow for a CSS process.

FIGS. 4A-B show an example of a method for assigning a consultant to support an enterprise system.

FIG. 5 shows an example of a process flow for a CSS process that involves a one-off contract approach.

FIG. 6 shows an example of a process flow for a CSS process that involves a call-off contract approach.

FIG. 7 is a block diagram of a computing system that can be used in connection with computer-implemented methods described in this document.

Like reference symbols in the various drawings indicate like elements.

### DETAILED DESCRIPTION

This document describes systems and techniques by which a consultant can be assigned to an enterprise system. For example, a consulting self-service (CSS) process can be implemented, and an enterprise system customer can enter relevant information, such as a brief description of what the customer needs. The CSS process can process the received information and based thereon find one or more candidate consultants to support the enterprise system. In some implementations, the CSS process controls and manages the entire procedure, including finding a suitable consultant, assuring that the consultant is available, negotiating the agreement for the work, ensuring that the work is done, collecting feedback from the customer, and updating the system based on whether the recommended consultant was a good fit for the project. The work performed by the consultant regarding the enterprise system can include, but is not limited to, configuration, end user education, end user training, design document or process document review, or other supporting functions, to name a few examples.

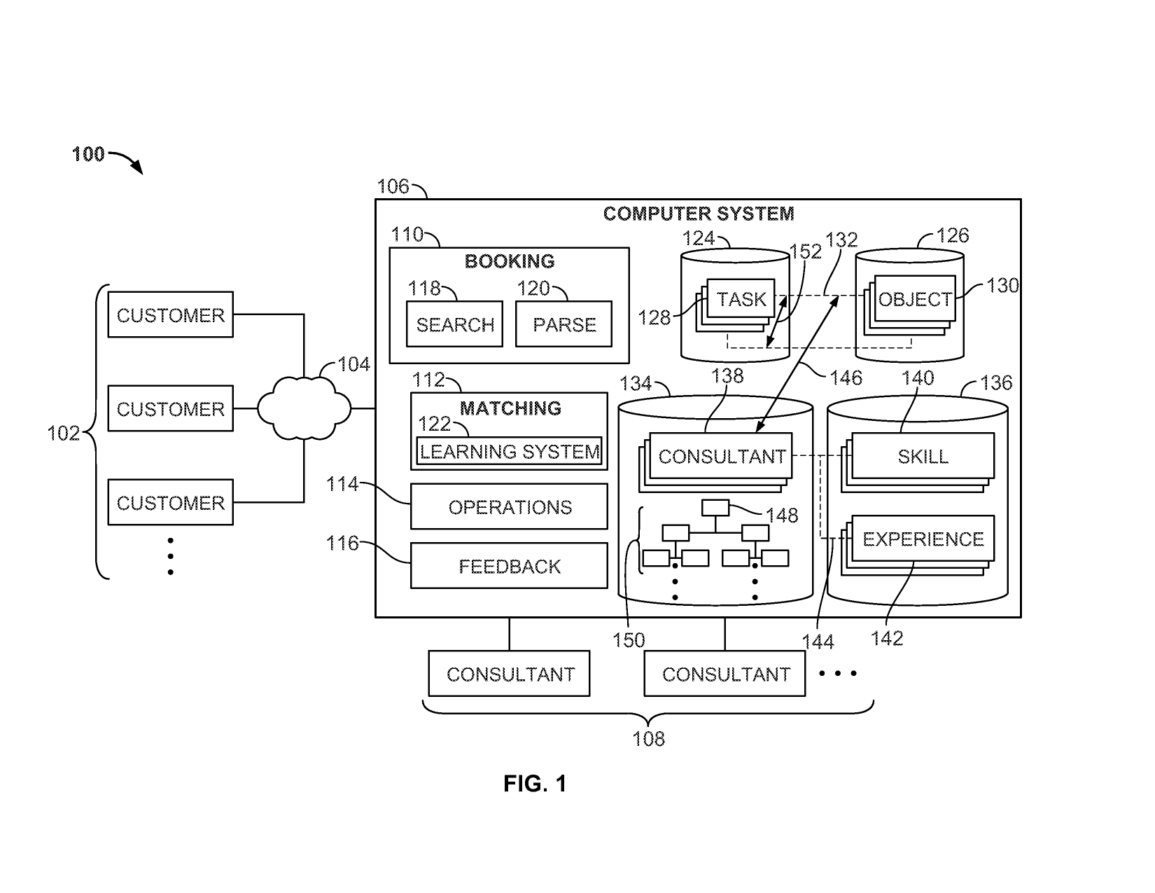

FIG. 1 shows an example of a system 100 that can assign a consultant to support an enterprise system. The system 100 includes one or more customer systems 102. The system(s) 102 can be used to perform and/or monitor one or more operations for an enterprise. In some implementations, the system 102 can be or include one or more enterprise resource planning (ERP) systems, such as, but not limited to, an ERP system available from SAP AG. The ERP system can include one or more of a business intelligence (BI) component, a customer relationship management (CRM) component, and/or a component interconnecting at least two devices, environments or platforms, to name just a few examples.

When any of the customer systems is delivered and/or installed to a particular customer, the system may not yet be fully ready to use. Instead, as is common with ERP systems, the customer may need to have extensive configuration performed to tailor the system's characteristics and functionality to the customer's needs. This work is performed by one or more consultants who should be experienced in the technical and functional features of the customer's system. The system 100 can automatically find and retain such consultant(s), for example to speed up the configuration process.

Each of the customer systems 102 is connected to one or more other systems by way of any kind of network 104, including, but not limited to, a local area network or the internet.

The system 100 here includes a computer system 106. In some implementations, the system 106 is operated by the manufacturer and/or designer of the enterprise system that the customer has bought or is intending to buy. For example, the manufacturer can run the system 106 as a way of providing a CSS process to its customers, and/or for other reasons. The computer system 106 here has multiple consultant systems 108 connected to it, and each consultant system can be operated by one or more consultants. In some implementations, some or all of the consultants are employees of the manufacturer.

The computer system 106 in this example provides a CSS process to its customers, for example to manage an entire engagement lifecycle for the consultant(s). In some implementations, the CSS process allows each of the customers to quickly find the right consultant(s) for the project, retain the consultant(s), make sure the work is performed and provide feedback. For these and other purposes, the computer system 106 here includes a booking module 110, a matching module 112, an operations module 114 and a feedback module 116.

The booking module 110 automates the complete process from finding the right consultant(s) until a sign-off phase for the consultant engagement. For example, the booking module provides a search function 118 so that the customer can initiate the search(es), and a parse function 120 that receives the customer's search input, scans it and determines what the customer's needs are. In some implementations, the search function 118 provides a search screen that allows free-text input and/or choices among categories.

The matching module 112 can perform a matching process to enable the system to match the right consultant(s) to the stated customer need. In some implementations, the matching module can include a learning system 122. Any suitable machine-learning or similar technique can be used. For example, the learning system can detect what consultants are recommend for specific customer inputs (i.e., for individual customer needs), and based on the feedback determine whether the recommendation was successful.

The operations module 114 can automate all necessary backend processes for the CSS procedure. This can include, but is not limited to, customer validation, legal online contract negotiation and formation, and billing.

The feedback module 116 allows at least the customers to submit their comments, concerns, evaluations and/or suggestions regarding the specific consultant engagement and the CSS process in general. For example, the customer can make input as free text and/or by choosing among predefined alternatives in different categories.

When a customer initiates a search for a consultant, the system scans the customer's input (e.g., free text), for example using the parser function 120. The system then chooses from a dynamically updated list at least one task and the solution that the task should be applied to. Tasks can include, but are not limited to, configuring, assessing, evaluating, comparing, implementing, upgrading, reviewing and qualifying, to name just a few examples. The relevant solutions depend on the enterprise system that the customer need configured. Solutions can include, but are not limited to, an ERP system, a BI system, a CRM system, and an interconnective system, to name just a few examples.

The computer system 106 here includes a task repository 124 and an object repository 126. In some implementations, the repositories can be implemented in a common storage. The task repository 124 includes multiple task identifiers 128. Each of the tasks “configure, assess, evaluate, compare, implement, upgrade, review and qualify” can have a separate one of the task identifiers 128, to name just some examples. The object repository 126 includes multiple object identifiers 130. Each solution of “ERP, BI, CRM, SAP Gateway, and report” can have a separate one of the object identifiers 130, to name just some examples.

The computer system 106 pairs up each of the task identifiers 128 with one or more of the object identifiers 130 into respective task-object pairs 132. That is, each of the task-object pairs 132 represents at least one task (indicated by the task identifier) to be performed on at least one object (indicated by the object identifier). The task-object pairs 132 can include “generate BI report” or “upgrade CRM sales,” to name just a few examples. For example, the task-object pairs can be stored in form of associations (e.g., individual references) between the specific task identifiers and object identifiers.

The computer system 106 here includes a consultant repository 134 and a skills and experience repository 136. In some implementations, the repositories can be implemented in a common storage. For example, the repositories 124, 126, 134 and/or 136 can be implemented in form of one or more database records. The consultant repository 134 includes multiple consultant identifiers 138. For example, each of the consultants operating the consultant systems 108 can be represented by a corresponding identifier. In some implementations, the consultant identifiers 138 serve to provide anonymization and/or other privacy protection, for example where required by law.

The skills and experience repository 136 includes multiple skills identifiers 140 and multiple experience identifiers 142. For example, each of the skills identifiers specifies a particular skill that any individual consultant may or may not have, depending on his or her background and education. Similarly, each of the experience identifiers specifies a particular experience that any individual consultant may or may not possess depending on his or her background and education.

The consultant identifiers 138 are associated, by associations 144, with specific ones of the skills identifiers 140 and/or the experience identifiers 142 as applicable to that individual consultant. This creates a record that reflects that consultant's characteristics and abilities in terms of his or her skills and experience. The associations 144 can be updated over time, for example based on completed projects, customer feedback, and/or additional input from the consultant.

For each consultant, the computer system 106 creates a link 146 to one or more of the task-object pairs 132. That is, the link 146 represents that particular consultant's ability (or not) to perform the specified task (e.g., an upgrade) on the specified object (e.g., a solution). In some implementations, the link can include one or more strength parameters. For example, a relatively high value of this parameter indicates that the consultant has successfully performed that task on the object in the past (perhaps more than once). The strength parameter value can be set based on customer feedback.

Consultants can be grouped into profiles 148 based on their skills and experience. As such, each of the profiles 148 can cluster those of the available consultants who have similar skills and/or experience. The profile can be used by the matching module 112. For example, if consultant A has successfully performed a particular task in the past and moreover has the same profile 148 as another consultant B, then, the matching module 112 (e.g., the learning system 122) can deduce that there is a high chance that consultant B can also successfully perform that task.

The matching module 112 can evaluate consultants, or tasks, or both, using a “circles of trust” concept. Regarding consultants, a first circle can relate to the particular consultant himself or herself. For example, if the consultant has successfully performed a task then the matching module can deem it virtually certain that the consultant can perform that task again. That is, a circle one can represent a highest level of trust. Similarly, if an individual consultant has not previously performed a particular task, but one or more consultants with the same profile as the individual consultant have performed the task, then the matching module 112 can conclude that the individual consultant can perform the task. For example, such an assumption can be considered more reliable if many of the consultants with the same profile have performed the task than if only a few have done so. This can be considered circle two for consultants.

The profiles 148 can be assigned to a tree-shaped taxonomy 150. The taxonomy 150 can have “CRM” as a node in the tree, and this node can be the parent node of “sales,” “marketing,” “mobile” etc., to name just a few examples. Each such lower node can in turn be the parent node for one or more other nodes. For two arbitrary profiles 148, the taxonomy 150 allows for definition of a “distance” between them. In some implementations, this distance can be used by the matching module 112 in deciding whether a particular consultant should be recommended for a specific one of the task-object pairs 132 (that is, to perform a certain task on a particular object). For example, if the distance is less than a particular threshold (which can depend on the task-object pair) then the consultant can be deemed capable of performing the task. Based on the flexibility in considering different distances, this can be considered circles three through n for consultants, where n is the maximum distance in the taxonomy 150.

Regarding an arbitrary task, the circle one for that task can indicate one or more other tasks that have successfully been performed by the same consultant. In some implementations, the matching module 112 can then consider those tasks closely linked. For example, those tasks may require similar skills to perform. If a particular consultant has successfully performed one of those tasks then the matching module may decide that the consultant is skilled to also perform the other of the tasks.

The level of trust can increase depending on how many tasks are closely linked. For example, if m number of tasks are marked as closely linked then a consultant who has already performed many of the tasks (e.g., m−1 of the tasks) can be assumed able to handle the mth task as well.

In short, based on a particular search from a customer one or more consultants can be identified based on the links 146 (e.g., a strength parameter) and recommended to the customer. If the customer selects a consultant but the consultant declines the project (other than for lack of time, etc.), this can lead to a negative impact on the link between that consultant and the particular task-object pair.

In some implementations, the computer system 106 can generate a link 152 between two or more of the task-object pairs 132. For example, the link 152 can be created when the learning system 122 detects that consultants with similar profiles successfully performed multiple ones of the task-object pairs 132. In some implementations, the link 152 can affect the links 146. For example, if a consultant has successfully performed some of the task-object pairs of the link 152, then the link 146 can be applied for that consultant to all of the task-object pairs of the link 152.

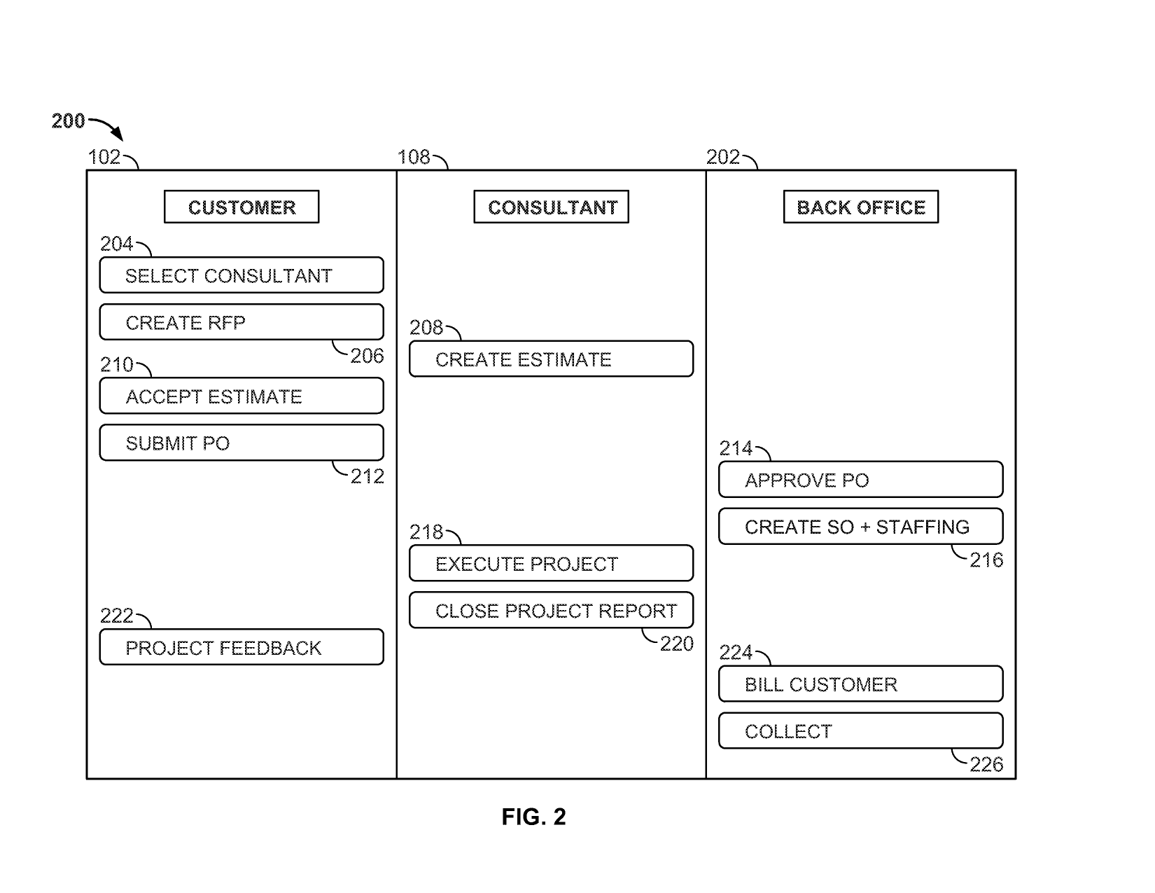

FIG. 2 shows an example of a process flow 200 for a CSS process. The process flow 200 can involve different variations of one or more systems. In this implementation, the process flow concerns the customer system 102, the consultant system 108 and a back office system 202. For example, the back office system 202 can correspond to the computer system 106 (FIG. 1).

At 204, a consultant is selected using the customer system 102. For example, a (customer) user can input one or more search terms into the customer system and this search is processed to determine at least one search criterion which is then used to identify the matching consultant(s). If there is more than one match, they can be presented as options for the user to choose between.

At 206, a request for proposal (RFP) is created using the customer system. For example, the RFP specifies the customer's needs in terms of the substantive work to be done, the timeframe for completion and an estimated budget, and requests the matching consultant(s) to generate an estimate for the customer if they are interested in the project. The RFP can be provided to one or more of the consultant system 108.

At 208, at least one consultant creates an estimate and provides it to the customer system. That is, the estimate can indicate what a particular consultant proposes the project should entail in terms of substantive work, scheduling and/or budget.

At 210, the customer accepts at least one received estimate. This acceptance can be communicated to the winning consultant as well as to any other consultant who submitted an estimate.

At 212, a purchase order (PO) is submitted from the customer system 102 to the back office system 202. That is, the PO can be a specific and detailed order that includes an offer from the customer to purchase the particular services (and/or materials or other goods). In this implementation, some or all of the available consultants are employees of the organization (e.g., a manufacturer of enterprise systems) who operates the back office system 202. The customer therefore submits the PO to the back office rather than, for example, directly to the winning consultant.

At 214, the PO is approved. In this implementation, the relevant processing is performed essentially all by the back office system 202 and it is therefore that system that handles the approval of the PO.

At 216, a sales order (SO) and staffing document is created. For example, the back office system 202 can generate the SO as a response to the received PO and corresponding to its specifications. The staffing document can specify the required consultant(s) and any other needed staff, if applicable.

At 218, the project is executed by the contracted consultant(s). For example, the consultant(s) can perform required configuration on the customer's enterprise system on site and/or through a remote connection.

At 220, the consultant system(s) can finish and close a project report regarding the finished work. For example, the consultant can report what work was done, what testing was performed, and whether any unexpected issues came up during the project.

At 222, the customer can provide feedback on the project. For example, the feedback can relate to whether the project was completed successfully, the competence of the consultant(s), the timeliness of the performed work, and/or the value of the services.

At 224, the back office system 202 can bill the customer for the performed work. For example, the invoice can be based on the SO that was created earlier.

At 226, the back office system 202 can collect payment from the customer. In some implementations, payment can be provided in more than one installation and/or through other customer-specific arrangements.

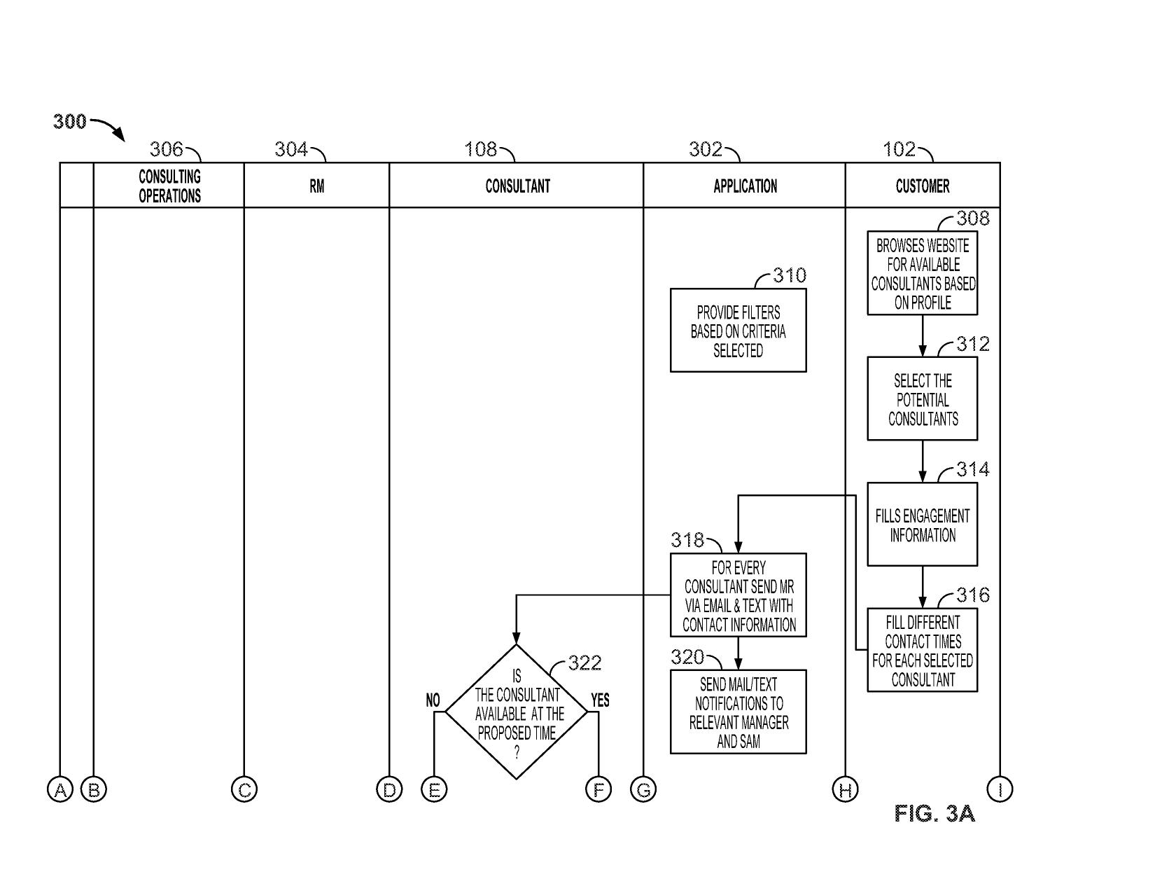

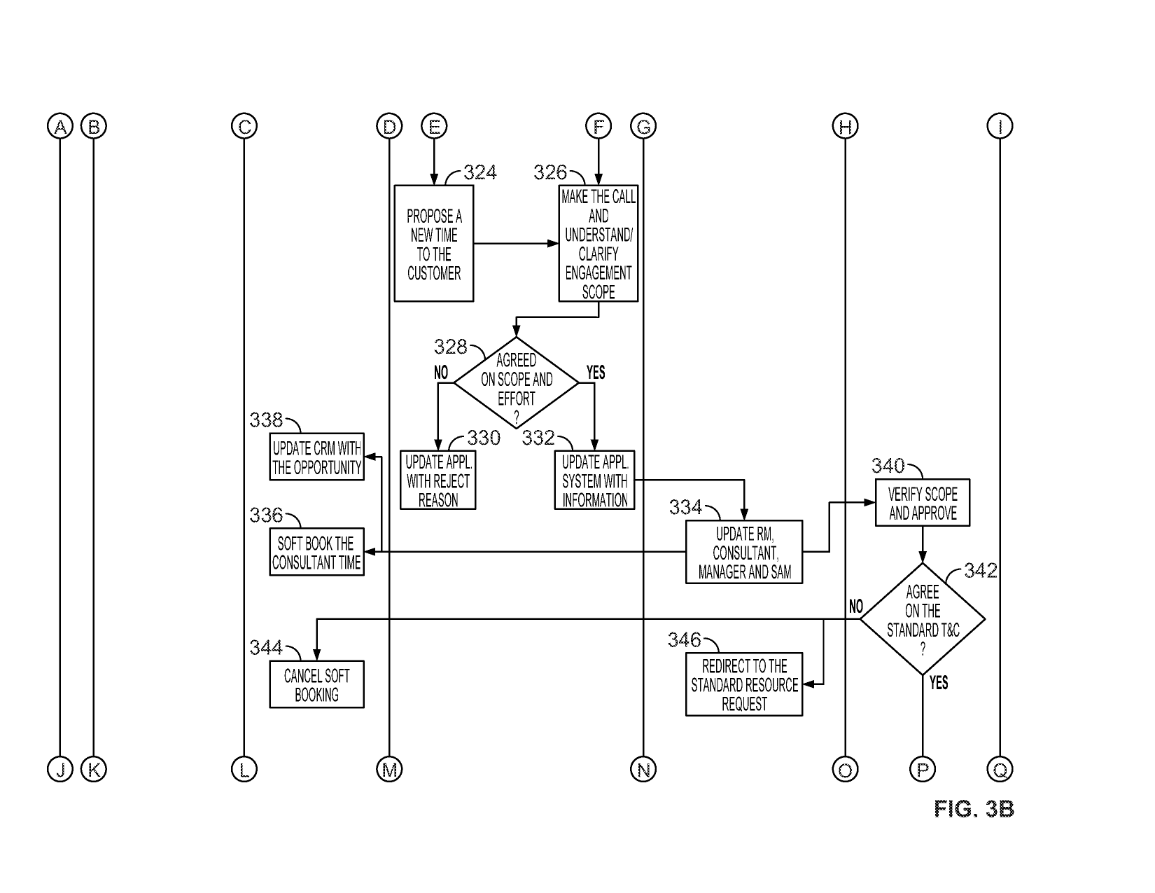

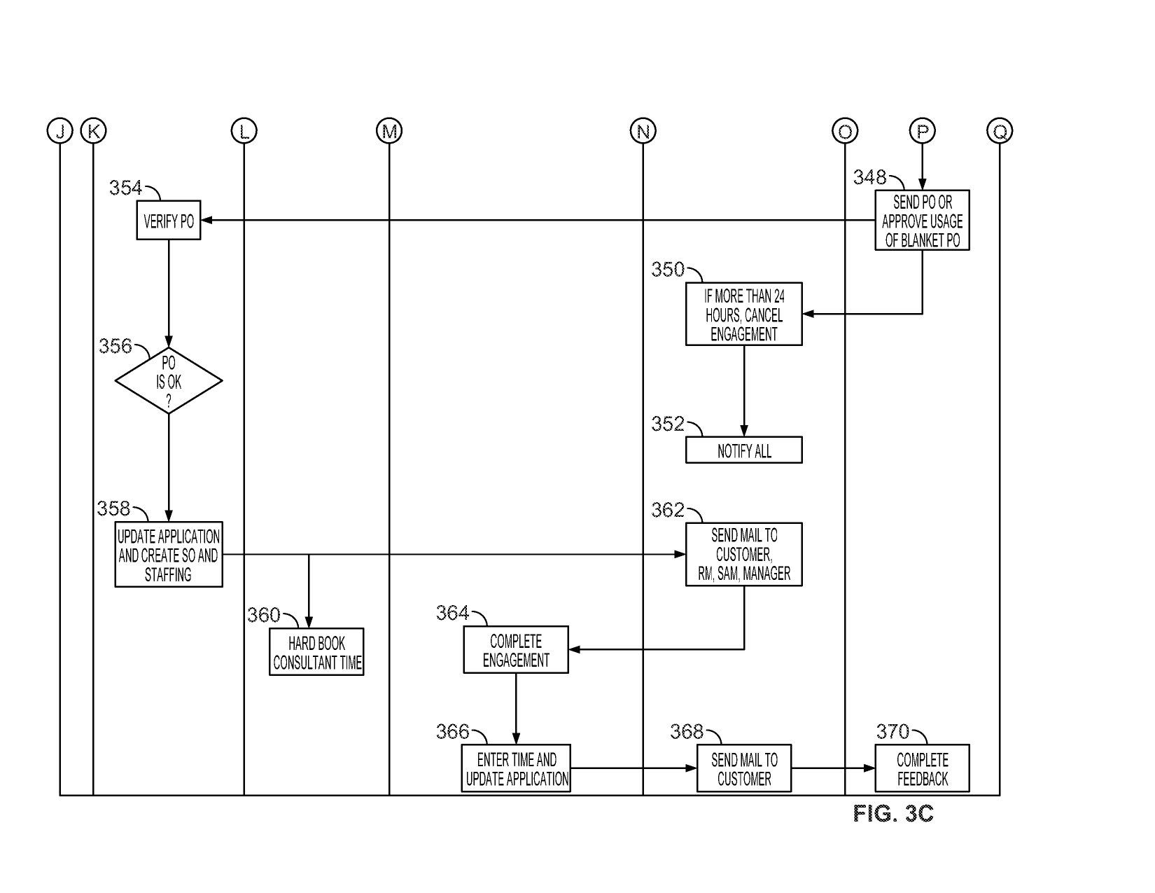

FIGS. 3A-C show an example of another process flow 300 for a consulting self-service process. The process flow 300 can involve different variations of one or more systems. In this implementation, the process flow concerns the customer system 102, an application system 302, the consultant system 108, a resource management (RM) system 304 and a consulting operations system 306. For example, the application system 302, the RM system 304 and/or the consulting operations system 306 can be included in the computer system 106 (FIG. 1).

At 308, and using the customer system, a customer can browse a website for available consultants based on profile. In some implementations, the application system can provide a filter based on one or more selected criteria at 310. At 312, the customer selects at least one consultant among the presented potential consultant(s). At 314, the customer fills in (e.g., using an online form) engagement information. At 316, the customer fills in at least one requested contact time for having an initial meeting with each selected consultant.

At 318, the application system sends, for each selected consultant, a meeting request (MR) (e.g., via email), including text regarding the proposed project and contact information regarding the customer. At 320, the application system can send one or more notifications to a relevant manager and a status and action management (SAM) system. For example, the consultant's manager can be notified by way of email or another text message.

At 322, the one or more consultant systems determine whether the requested consultant is available for a meeting at the proposed time. If not, a new time can be proposed to the customer at 324. When a suitable time has been found, the meeting with the customer is conducted (e.g., by phone or videoconference) at 326. For example, this meeting can help the consultant(s) understand or clarify the scope of the proposed engagement. At 328, the consultant system determines whether an agreement was reached (at least in principle) as to the scope of the project and the effort required to complete the project. If not, the consultant system can update the application system at 330. For example, the reason for the lack of agreement can be provided. Otherwise, the application system can be updated at 332 with information regarding the outcome of the meeting with the customer.

The application system, in turn, can make one or more updates at 334. For example, the RM system, consultant system, a manager and/or the SAM system can be updated with information regarding the preliminary agreement. The RM system can soft book the at least one consultant's time at 336 and can also update a customer relationship management (CRM) system at 338 regarding the opportunity represented by the preliminarily agreed-on consulting project.

At 340, the customer system can verify the scope of the proposed project and approve the project as currently specified. In some implementations, the application system can provide standard terms and conditions (T&C) and the customer system can accept or reject these at 342. If rejected, the RM system can cancel the soft booking of the consultant(s) at 344. In some implementations, a rejection of the standard T&C can cause the application system to redirect the customer at 346. For example, the customer can be redirected to an alternative consultant engagement process that is less automated than that represented by the process flow 300. If the customer system indicates acceptance of the standard T&C, then the customer system can provide a PO at 348. In some implementations, the customer system can instead approve that a blanket PO be used.

One or more time deadlines can be applied to the process of booking a consultant. For example, at 350 the application system can determine whether more than, say, 24 hours have passed since the PO was issued. If so, the engagement can be canceled. In some implementations, one or more notices can then be sent at 352.

After the customer system sends the PO (or approves a blanket PO) at 348, the consulting operations system can verify the PO at 354. For example, this can involve checking that the PO is correct and complete, and that the one or more consultants are properly specified (e.g., by an employee ID). If the PO is not verified, one or more corrective measures can be taken at 356. For example, missing information can be obtained. When the PO is verified, the consulting operations system at 358 can update the application system and create the SSO and staffing documentation. This can trigger the RM system to hard book the required time for the consultant(s) at 360. At 362, the application system can send one or more messages. For example, an email can be sent to the customer, the RM system, the SAM system and/or the manager of the consultant(s).

At 364, the consultant can complete the engagement. For example, the consultant(s) perform the configuration work on the customer's enterprise system as agreed. The consultant can make a time entry for his or her work at 366. Also the application system can be updated regarding this status.

The application system can contact the customer at 368. For example, the customer can be contacted by email and requested to complete an online evaluation regarding the project. At 370, the customer can provide the requested feedback.

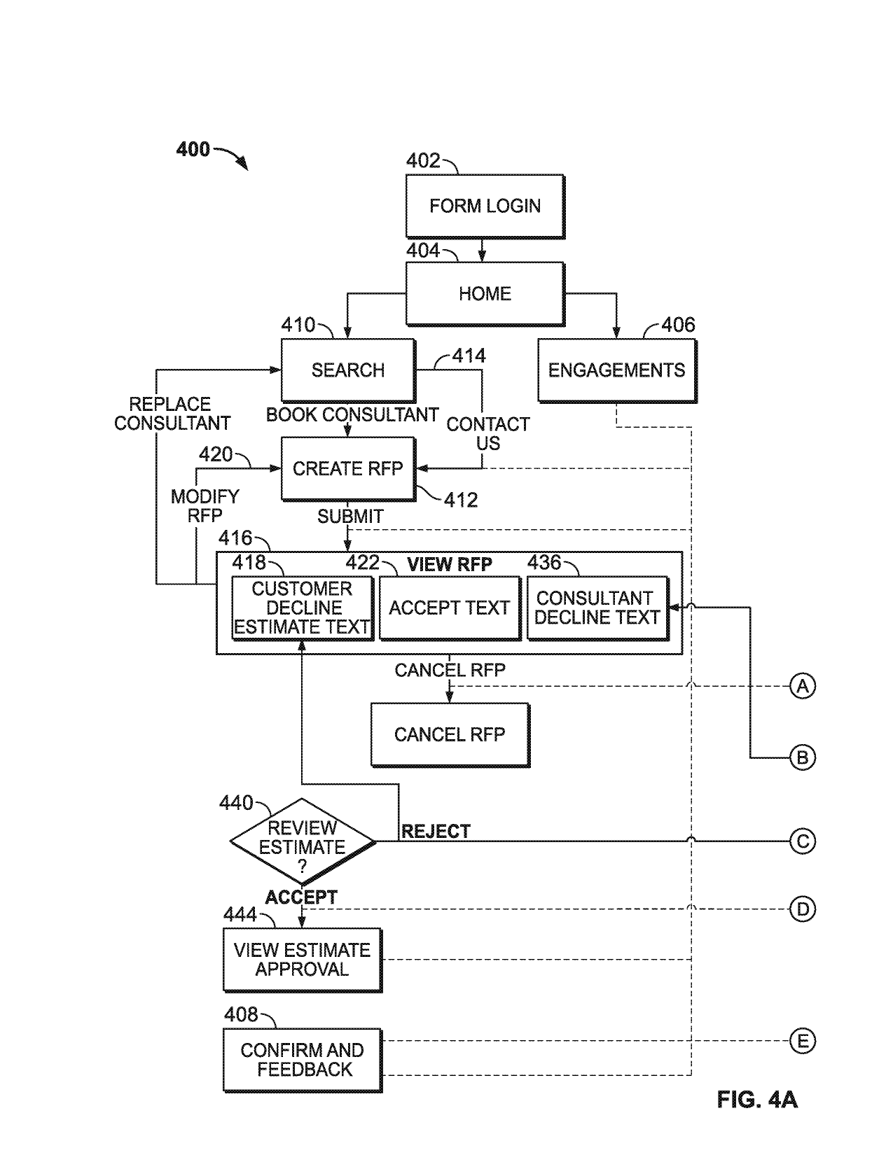

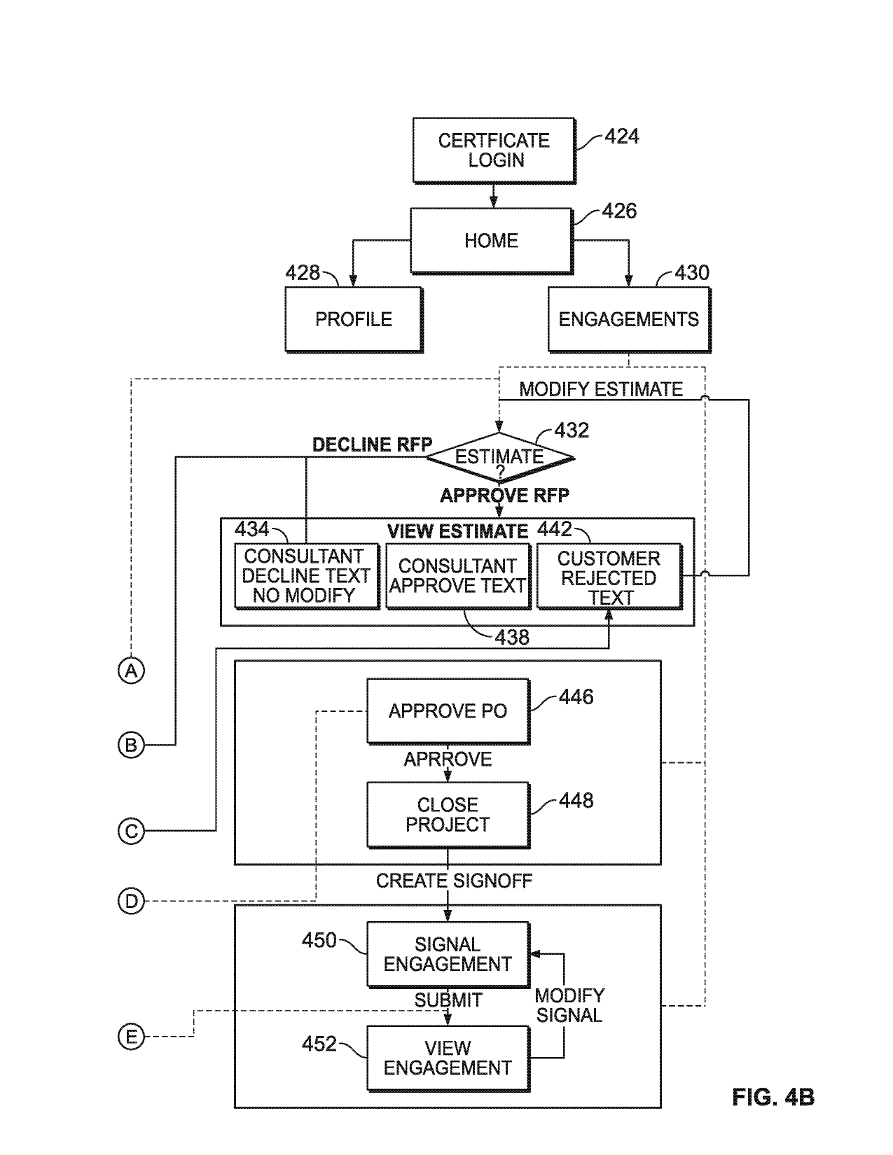

FIGS. 4A-B show an example of a method 400 for assigning a consultant to support an enterprise system. The method 400 can be performed using one or more systems, for example the system 100 (FIG. 1). Generally, the method 400 can be said to have a customer side and a consultant side. At 402, a customer is presented a form login page on the customer side of the method.

After successfully logging in, the customer is presented a home page at 404. For example, the home page can provide options for the customer to choose between when seeking to retain a consultant for a project. An engagements option 406 allows the customer to view any existing engagements. For example, the customer can review the status of any consultation projects that are in progress or that have been completed. A confirm and feedback function 408 can be used to confirm that the project has been completed as agree and/or to provide feedback on the consultant.

A search option 410 on the home page allows the customer to initiate a new search for a consultant, perhaps regarding a new project. For example, the customer can enter search criteria and choose among the consultants presented as possible candidates. If the customer chooses to book a consultant, a request for proposal (RFP) regarding the consultant/project can be provided at 412. In some implementations, the user can choose a “contact us” option at 414 which can involve a search process that is at least in part based on individuals in the organization investigating the customer's needs and making recommendations for suitable consultants.

A view RFP function 416 allows the customer to view the created RFP. The customer can choose to decline the estimate text at 418, and the RFP can then be modified at 420 (e.g., the text can be changed). If the user accepts the text at 422 then the RFP will be provided so that it can be considered by the consultant.

The consultant can login using a certificate login 424, which can be said to begin the consultant side of the method. The consultant can be presented a home page at 426. The home page can provide the consultant access to his or her profile 428. In some implementations, the profile can be presented directly on the home page. An engagements function 430 provides the consultant access to one or more engagements. For example, the consultant can access one or more RFPs that have been generated by customers.

The consultant can use an estimate function 432 to decide whether to accept or decline the RFP. If the consultant declines the text at 434, then the estimate is not modified and the customer can be presented with a “consultant decline text” message 436 in the view RFP function 416. If the consultant approves the text then the estimate is provided to the customer using function 440, where the customer has the choice of accepting or rejecting the consultant's estimate for the proposed project. If the customer rejects, the consultant can be presented with a “customer rejected text” message 442. If the customer accepts, then an estimate approval view 444 is provided.

The consultant can be provided a function 446 to approve the PO for the proposed project. When approved, the project can be closed at 448. The consultant can create a signoff for the project, and a signoff engagement function 450 can be performed, followed by a view engagement function 452, which can allow the consultant to modify the signoff.

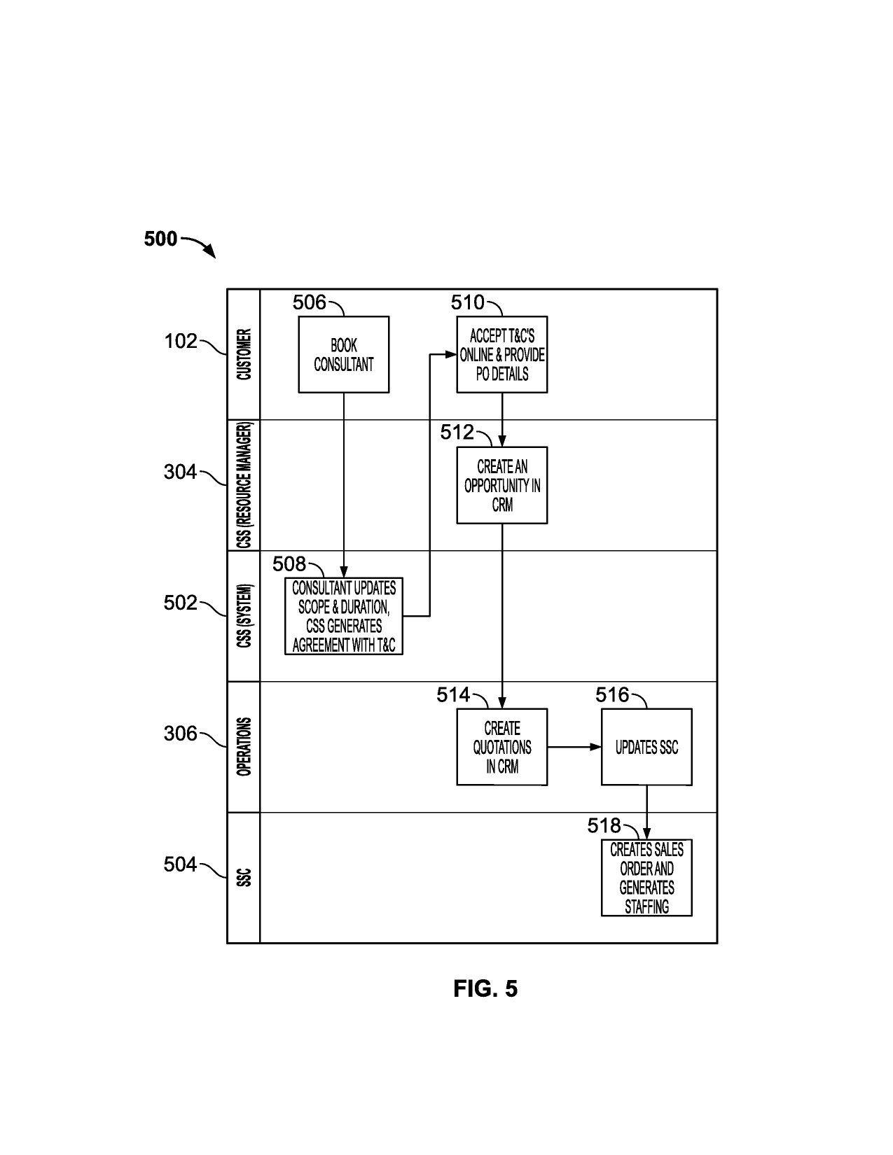

FIG. 5 shows an example of a process flow 500 for a consulting self-service process that involves a one-off contract approach. In some implementations, the one-off approach can involve the customer engaging a consultant for only a specific occurrence (e.g., a one-time project). This can be contrasted with another approach where the customer has an ongoing ability to engage on new consultations without going through the entire process again, which will be described in a later example.

The process flow 500 can involve different variations of one or more systems. In this implementation, the process flow concerns the customer system 102, the resource management system 304, a consultant self-service (CSS) system 502, the consulting operations system 306 and a standard service catalog (SSC) system 504. For example, the resource management system 304, the CSS system 502, the consulting operations system 306 and the SSC system 504 can be included in the computer system 106 (FIG. 1).

At 506, the customer system can book one or more consultants. At 508, the CSS system can provide one or more updates. For example, the consultant can update the scope and/or duration of the project. In some implementations, the CSS system generates an agreement document with terms and conditions. At 510 the customer can accept the terms and conditions using the customer system. In some implementations, the customer can provide PO details regarding the proposed project. At 512 the CSS system can create an opportunity in a CRM system regarding the possible project.

At 514, the consultant operations system can create one or more quotations in the CRM system. The consultant operations system can update the SSC system at 516. In turn, the SSC system can create a sales order and a staffing document at 518.

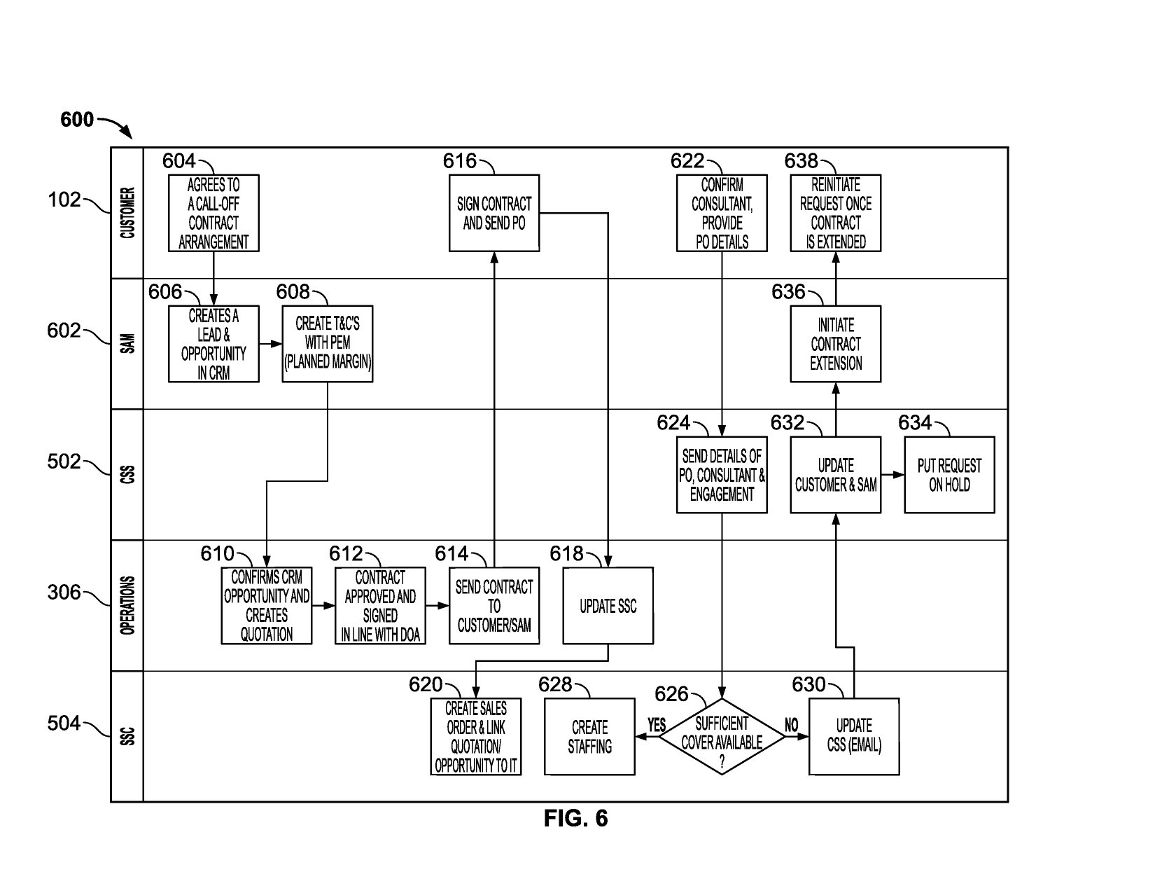

FIG. 6 shows an example of a process flow 600 for a consulting self-service process that involves a call-off contract approach. In some implementations, the call-off approach involves the customer having an ongoing ability to engage on new consultations without going through the entire process again.

The process flow 600 can involve different variations of one or more systems. In this implementation, the process flow concerns the customer system 102, a status and action management (SAM) system 602, the CSS system 502, the consulting operations system 306 and the SSC system 504. For example, the SAM system 602, the CSS system 502, the consulting operations system 306 and the SSC system 504 can be included in the computer system 106 (FIG. 1).

At 604, the customer can agree to a call-off contract. In some implementations, the customer enters into this agreement with the consultant's employer (e.g., the company manufacturing the enterprise system). At 606, the SAM system can create a lead and an opportunity in a CRM system. At 608, the SAM system can create terms and conditions with a planned margin. At 610, the consultant operations system can confirm the CRM opportunity and create a corresponding quotation. At 612, the contract can be approved and signed in line with the applicable delegation of authority (DOA). At 614, the consultant operations system can send the contract to the customer and/or to the SAM system.

At 616, the customer can sign the contract and send a corresponding PO. At 618, the consultant operations system can update the SSC system accordingly. The SSC system can create a sales order at 620 and link the quotation or opportunity to it.

At 622, the customer can confirm the consultant and provide PO details. At 624, the CSS system can send details of the PO, the consultant and the engagement. At 626, the SSC system can determine whether sufficient cover is available. If so, a staffing document can be created at 628.

If sufficient cover is not available, the CSS system can be updated at 630 (e.g., by email). The CSS system can update the customer and the SAM system at 632. The request can be put on hold at 634. At 636, the SAM system can initiate a contract extension. At 638, the customer system can reinitiate the request once the contract is extended.

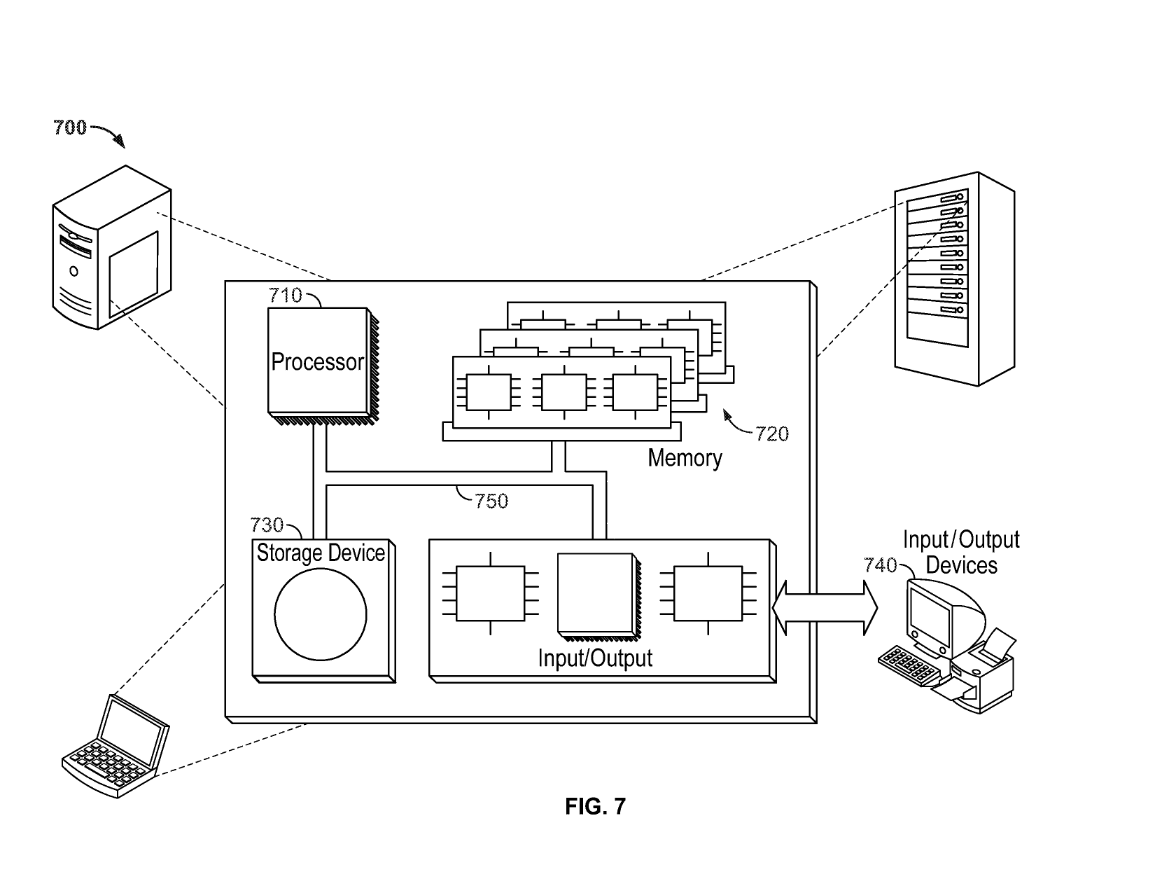

FIG. 7 is a schematic diagram of a generic computer system 700. The system 700 can be used for the operations described in association with any of the computer-implement methods described previously, according to one implementation. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. The memory 720 is a volatile memory unit in some implementations and is a non-volatile memory unit in other implementations.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

1. A computer-implemented method for assigning a consultant to an enterprise system, the method comprising:
receiving, by a first computer system and from a second computer system, an input that indicates a need regarding an enterprise system, wherein the input corresponds to a search for one or more consultants to satisfy the need regarding the enterprise system, and wherein the second computer system is associated with a customer and the first computer system is associated with an entity other than the customer;
selecting, based on the input and using one or more processors of the first computer system, at least one of multiple task-object pairs as corresponding to the need, each of the task-object pairs including a task identifier and an object identifier, wherein the object identifier specifies an aspect of the enterprise system and the task identifier specifies a task performed on the aspect;
selecting, in a consultant repository and using the one or more processors of the first computer system, one or more consultant identifiers as being associated with the selected at least one task-object pair; and
presenting the selected one or more consultant identifiers in response to the input.

2. The computer-implemented method of claim 1, wherein a customer who made the input selects one of the presented consultant identifiers for the need, the method further comprising:
providing, to the second computer system that is associated with the customer, terms and conditions for work to be performed, wherein the terms and conditions are based at least in part on the need and wherein the work is to be performed by a consultant that corresponds to the selected one of the presented consultant identifiers;
receiving, from the second computer system, a confirmation that the terms and conditions have been accepted by the customer associated with the second computer system;
receiving, from the second computer system, a purchase order that corresponds to the work to be performed;
verifying, by the first computer system, the received purchase order; and
booking, by the first computer system, the consultant based at least in part on i) the terms and conditions that are accepted by the customer and ii) the purchased order that has been verified by the first computer system.

3. The computer-implemented method of claim 1, further comprising assigning identifiers in the consultant repository to respective ones of multiple profiles, wherein selecting the one or more consultant identifiers comprises determining whether a candidate consultant having a first profile has previously performed the task, and if not, determining whether another candidate consultant having the first profile has previously performed the task.

4. The computer-implemented method of claim 3, further comprising organizing the multiple profiles in a tree-shaped taxonomy, wherein the tree-shaped taxonomy includes a plurality of nodes and a plurality of links that each connect at least two of the plurality of nodes to each other in the tree-shaped taxonomy, wherein at least a portion of the plurality of nodes represent the multiple profiles, and wherein selecting the one or more consultant identifiers comprises:
determining a distance value between a first node and a second node in the tree-shaped taxonomy, wherein at least one of the first node and the second node represents a profile from the multiple profiles and wherein the distance value is based on, for a path that connects the first node and the second node in the tree-shaped taxonomy, a number of links in the tree-shaped taxonomy that comprise the path between the first node and the second node;
comparing the determined distance value to a threshold distance value; and
selecting at least one profile represented by at least one of the first node and the second node based on the comparison between the determined distance value and the threshold distance value.

5. The computer-implemented method of claim 3, further comprising associating at least two task identifiers with each other based on the candidate consultant having performed at least two tasks corresponding to the task identifiers, wherein selecting the one or more consultant identifiers comprises taking into account the association.

6. The computer-implemented method of claim 1, further comprising receiving performance feedback regarding the need for at least one of the presented consultant identifiers, and updating the association between the at least one consultant and the task-object pair using the performance feedback.

7. The computer-implemented method of claim 6, further comprising associating at least two task-object pairs with each other based on consultants having performed at least two tasks corresponding to the task identifiers, wherein selecting the one or more consultant identifiers comprises taking into account the association.

8. A computer program product embodied in a non-transitory computer-readable storage medium and comprising instructions that when executed by a processor perform a method for assigning a consultant to an enterprise system, the method comprising:
receiving, by a first computer system and from a second computer system, an input that indicates a need regarding an enterprise system, wherein the input corresponds to a search for one or more consultants to satisfy the need regarding the enterprise system, and wherein the second computer system is associated with a customer and the first computer system is associated with an entity other than the customer;
selecting, based on the input and using one or more processors of the first computer system, at least one of multiple task-object pairs as corresponding to the need, each of the task-object pairs including a task identifier and an object identifier, wherein the object identifier specifies an aspect of the enterprise system and the task identifier specifies a task performed on the aspect;
selecting, in a consultant repository and using the one or more processors of the first computer system, one or more consultant identifiers as being associated with the selected at least one task-object pair; and
presenting the selected one or more consultant identifiers in response to the input.

9. The computer program product of claim 8, wherein a customer who made the input selects one of the presented consultant identifiers for the need, the method further comprising:
providing, to the second computer system that is associated with the customer, terms and conditions for work to be performed, wherein the terms and conditions are based at least in part on the need and wherein the work is to be performed by a consultant that corresponds to the selected one of the presented consultant identifiers;
receiving, from the second computer system, a confirmation that the terms and conditions have been accepted by the customer associated with the second computer system;
receiving, from the second computer system, a purchase order that corresponds to the work to be performed;
verifying, by the first computer system, the received purchase order; and
booking, by the first computer system, the consultant based at least in part on i) the terms and conditions that are accepted by the customer and ii) the purchased order that has been verified by the first computer system.

10. The computer program product of claim 8, further comprising assigning identifiers in the consultant repository to respective ones of multiple profiles, wherein selecting the one or more consultant identifiers comprises determining whether a candidate consultant having a first profile has previously performed the task, and if not, determining whether another candidate consultant having the first profile has previously performed the task.

11. The computer program product of claim 10, the method further comprising organizing the multiple profiles in a tree-shaped taxonomy, wherein the tree-shaped taxonomy includes a plurality of nodes and a plurality of links that each connect at least two of the plurality of nodes to each other in the tree-shaped taxonomy, wherein at least a portion of the plurality of nodes represent the multiple profiles, and wherein selecting the one or more consultant identifiers comprises:
determining a distance value between a first node and a second node in the tree-shaped taxonomy, wherein at least one of the first node and the second node represents a profile from the multiple profiles and wherein the distance value is based on, for a path that connects the first node and the second node in the tree-shaped taxonomy, a number of links in the tree-shaped taxonomy that comprise the path between the first node and the second node;
comparing the determined distance value to a threshold distance value; and
selecting at least one profile represented by at least one of the first node and the second node based on the comparison between the determined distance value and the threshold distance value.

12. The computer program product of claim 10, the method further comprising associating at least two task identifiers with each other based on the candidate consultant having performed at least two tasks corresponding to the task identifiers, wherein selecting the one or more consultant identifiers comprises taking into account the association.

13. The computer program product of claim 8, the method further comprising receiving performance feedback regarding the need for at least one of the presented consultant identifiers, and updating the association between the at least one consultant and the task-object pair using the performance feedback.

14. The computer program product of claim 13, the method further comprising associating at least two task-object pairs with each other based on consultants having performed at least two tasks corresponding to the task identifiers, wherein selecting the one or more consultant identifiers comprises taking into account the association.

15. A system comprising:
one or more processors; and
a computer program product comprising instructions that when executed by the one or more processors cause performance of a method, the method comprising:
receiving, by a first computer system and from a second computer system, an input that indicates a need regarding an enterprise system, wherein the input corresponds to a search for one or more consultants to satisfy the need regarding the enterprise system, and wherein the second computer system is associated with a customer and the first computer system is associated with an entity other than the customer;
selecting, based on the input and using one or more processors of the first computer system, at least one of multiple task-object pairs as corresponding to the need, each of the task-object pairs including a task identifier and an object identifier, wherein the object identifier specifies an aspect of the enterprise system and the task identifier specifies a task performed on the aspect;
selecting, in a consultant repository and using the one or more processors of the first computer system, one or more consultant identifiers as being associated with the selected at least one task-object pair; and
presenting the selected one or more consultant identifiers in response to the input.

16. The system of claim 15, wherein a customer who made the input selects one of the presented consultant identifiers for the need, the method further comprising:
providing, to the second computer system that is associated with the customer, terms and conditions for work to be performed, wherein the terms and conditions are based at least in part on the need and wherein the work is to be performed by a consultant that corresponds to the selected one of the presented consultant identifiers;
receiving, from the second computer system, a confirmation that the terms and conditions have been accepted by the customer associated with the second computer system;
receiving, from the second computer system, a purchase order that corresponds to the work to be performed;
verifying, by the first computer system, the received purchase order; and
booking, by the first computer system, the consultant based at least in part on i) the terms and conditions that are accepted by the customer and ii) the purchased order that has been verified by the first computer system.

17. The system of claim 15, the method further comprising assigning identifiers in the consultant repository to respective ones of multiple profiles, wherein selecting the one or more consultant identifiers comprises determining whether a candidate consultant having a first profile has previously performed the task, and if not, determining whether another candidate consultant having the first profile has previously performed the task.

18. The system of claim 17, the method further comprising organizing the multiple profiles in a tree-shaped taxonomy, wherein the tree-shaped taxonomy includes a plurality of nodes and a plurality of links that each connect at least two of the plurality of nodes to each other in the tree-shaped taxonomy, wherein at least a portion of the plurality of nodes represent the multiple profiles, and wherein selecting the one or more consultant identifiers comprises:
determining a distance value between a first node and a second node in the tree-shaped taxonomy, wherein at least one of the first node and the second node represents a profile from the multiple profiles and wherein the distance value is based on, for a path that connects the first node and the second node in the tree-shaped taxonomy, a number of links in the tree-shaped taxonomy that comprise the path between the first node and the second node;
comparing the determined distance value to a threshold distance value; and
selecting at least one profile represented by at least one of the first node and the second node based on the comparison between the determined distance value and the threshold distance value.

19. The system of claim 17, the method further comprising associating at least two task identifiers with each other based on the candidate consultant having performed at least two tasks corresponding to the task identifiers, wherein selecting the one or more consultant identifiers comprises taking into account the association.

20. The system of claim 15, the method further comprising receiving performance feedback regarding the need for at least one of the presented consultant identifiers, updating the association between the at least one consultant and the task-object pair using the performance feedback, and associating at least two task-object pairs with each other based on consultants having performed at least two tasks corresponding to the task identifiers, wherein selecting the one or more consultant identifiers comprises taking into account the association.
